(19) United States
(12) Patent Application Publication
(10) Pub. No.: US 2010/0031828 A1
(43) Pub. Date: Feb. 11, 2010

(54) GRILL WITH SLIGHT PRESSURE

(75) Inventor: Xingzhi LI, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/536,745

(22) Filed: Aug. 6, 2009

(30) Foreign Application Priority Data
Aug. 7, 2008 (CN) 200820103346.4

(51) Int. Cl. A47J 37/06

(52) U.S. Cl. 99/349

(57) ABSTRACT

The invention relates to a slight pressure grill, comprising a base with an upper opening, a grill pan disposed on the opening, an upper lid covered on the grill pan, and a sealing ring between the upper lid and the grill pan. Compare with the prior arts, when the upper lid is covered on the grill pan, the sealing ring will enclose a chamber and a certain amount of pressure will be generated therein, which can speed food cooking, prevent moisture content, oil steam and heat running off.

### FIELD OF THE INVENTION

The invention relates to a grill, more particularly to a grill with slight pressure.

### RELATED ART

Traditional grill usually comprises a base, a grill pan and a lid. The lid is covered on the grill pan to prevent moisture content, oil steam and heat running off, but moisture content, oil steam and heat still can run off from the gap between the lid and the grill pan. That will waste much moisture content, oil steam and heat.

ZL 200720122967.2 discloses a double-faced frying pan. The frying pan adopts a lid that has the same structure with the ordinary pressure cooker. The lid has locking parts. Although the frying pan can reduce lampblack and heat waste, it is not fit for ordinary grills and is discommodious to use.

### SUMMARY OF THE INVENTION

The invention provides a grill with slight pressure, which overcomes the disadvantages of leaking of moisture content, oil steam and heat.

The present invention adopts technical solution to overcome the shortcomings as follows:

A grill with slight pressure comprises a base with an upper opening, a grill pan disposed on the opening, an upper lid covered on the grill pan, and a sealing ring between the upper lid and the grill pan.

Said upper lid comprises a main body and a supporting plate disposed on the underneath of the main body; said sealing ring is fixed to the supporting plate.

The rear side of said main body is hinged on the top of the rear side of said base.

The front side of said main body protrudes forward to form a handle part; a handle lid is fixed to the handle part; a handle fastener is fixed to the handle lid; the handle fastener protrudes downwards to form a hook; the front of said base has a hole matched with the hook; the main body is locked to the base by the hook and the hole.

The upside of said main body has an opening; a glass lid is disposed on the opening; there is a second sealing ring between the glass lid and the opening.

There is a relief valve in said glass lid.

Said glass lid is transparent.

Said sealing ring is silica gel ring.

Said hook is V-shaped.

According to above-mentioned descriptions, the present invention overcomes the disadvantages of related art and has advantages as follows:

1. There is a sealing ring between the upper lid and the grill pan; when the upper lid is covered on the grill pan, the sealing ring will enclose a chamber and a certain amount of pressure will be generated therein, which can speed food cooking, prevent moisture content, oil steam and heat running off.

2. Because the rear side of said main body is hinged on the top of the rear side of the base, the upper lid can turn relatively to the base. It is convenient for use.

3. The main body is locked to the base by the V-shaped hook and the hole. That can make the seal between the upper lid and the grill pan more reliable.

4. There is a transparent glass lid disposed on the upside of the main body; the user can see whole grilling process, that is convenient for the user to adjust grilling process in time.

5. There is a relief valve deposed on said glass lid, the pressure in the grilling chamber can be released before raising the upper lid. That make the grill with slight pressure of the invention is safer to use.

### BRIEF DESCRIPTION OF THE DRAWINGS

FIG. 1 is a cutaway view of the preferred embodiment of the invention.

FIG. 2 is an explosive view of the upper lid of the preferred embodiment of the invention;

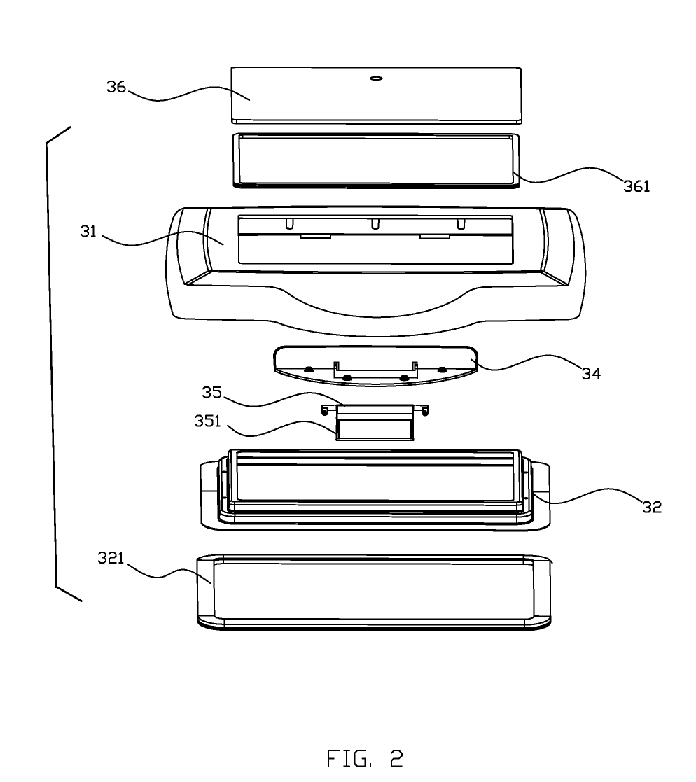

FIG. 3 is a three-dimensional structure diagram of the preferred embodiment of the invention.

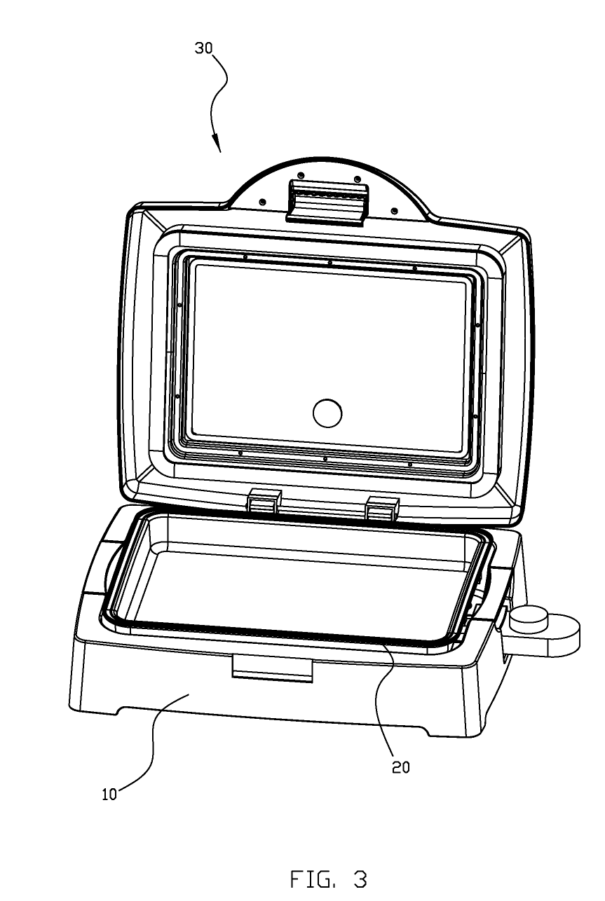

### DETAILED DESCRIPTION OF THE PREFERRED EMBODIMENTS

The invention will be further described by embodiment as follows.

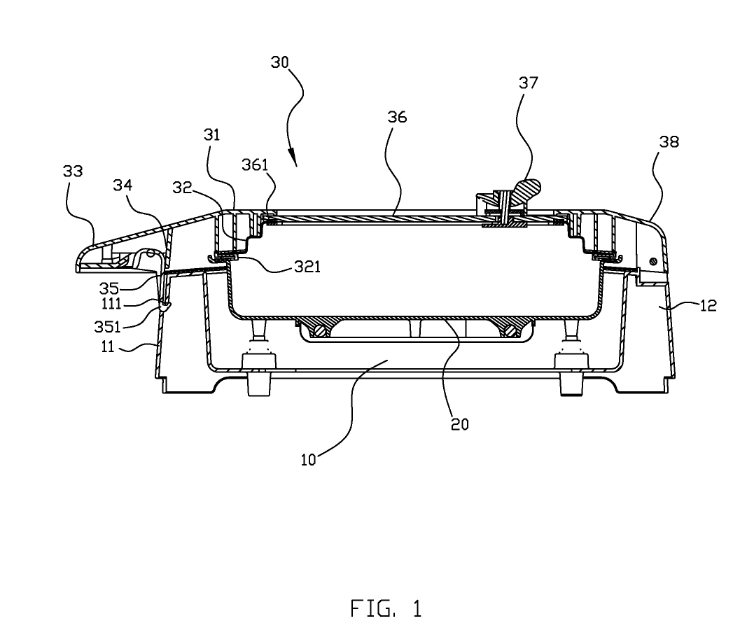

Referring to FIGS. 1,2,3, a grill with slight pressure comprises a base 10 with an upper opening, a grill pan 20 disposed on the opening and an upper lid 30 covered on the grill pan 20; there are electrothermal device and baffle-board in the base 10.

The upper lid 30 comprises a main body 31; a supporting plate 32 is disposed on the underneath of said main body 31; a first sealing ring 321 is fixed to the supporting plate 32. When the upper lid 30 is covered on the grill pan 20, the first sealing ring 321 is sealed between the grill pan 20 and the supporting plate 32. The rear side 38 of the main body 31 is hinged on the top of the rear side 12 of the base 10. There is a handle on the grill pan 20.

The front side of the main body 31 protrudes forward to form a handle part 33; a handle lid 34 is fixed to the handle part 33; a handle fastener 35 is fixed to the handle lid 34; the handle fastener 35 protrudes downwards to form a hook 351; the front 11 of the base 10 has a hole 111 matched with the hook 351; the upper lid 30 is locked to the base 10 by the V-shaped hook 351 and the hole 111.

The upside of the main body 31 has an opening; a transparent glass lid 36 is disposed on the opening; there is a second sealing ring 361 between the transparent glass lid 36 and the opening. There is a relief valve 37 in the transparent glass lid 36.

When the upper lid 30 is not covered on the base 10, the grill can carry out its common grilling function; when the upper lid 30 is covered on the base 10 by the V-shaped 351 and the hole 111, the first sealing ring 321 fixed to the supporting plate 32 will press out the brim of the grill pan 20 to make the grill pan 20 be sealed, and a certain amount of pressure will be generated therein to make the food can be cooked faster.

The foregoing description of the exemplary embodiment of the invention has been presented for the purposes of illustration and description. It is not intended to be exhaustive or to limit the invention to the precise form disclosed. Many modifications and variations are possible in light of the above teaching. All changes that come within the meaning and range of equivalency of the claims are to be embraced within their scope.

What is claimed is:

1. A grill with slight pressure comprises a base with an upper opening, a grill pan disposed on the opening, an upper lid covered on the grill pan, and a first sealing ring between said upper lid and said grill pan.

2. The grill with slight pressure according to claim 1, wherein said upper lid comprises a main body and a supporting plate disposed on the underneath of said main body; said sealing ring is fixed to said supporting plate.

3. The grill with slight pressure according to claim 2, wherein the rear side of said main body is hinged on the top of the rear side of said base.

4. The grill with slight pressure according to claim 2, wherein the front side of said main body protrudes forward to form a handle part; a handle lid is fixed to said handle part; a handle fastener is fixed to said handle lid; said handle fastener protrudes downwards to form a hook; the front of said base has a hole matched with the hook; said main body is locked to the base by the hook and the hole.

5. The grill with slight pressure according to claim 2, wherein the upside of said main body has an opening; a glass lid is disposed on said opening; there is a second sealing ring between the glass lid and the opening.

6. The grill with slight pressure according to claim 5, wherein said glass lid comprises a relief valve.

7. The grill with slight pressure according to claim 5, wherein said glass lid is transparent.

8. The grill with slight pressure according to claims 1, wherein said sealing ring is silica gel ring.

9. The grill with slight pressure according to claim 4, wherein said hook is V-shaped.
